(19) United States
(12) Patent Application Publication
(10) Pub. No.: US 2007/0147051 A1
(43) Pub. Date: Jun. 28, 2007

(54) Lamp housing, a protective cover, and a lamp replacement method for a light source apparatus

(75) Inventors: Katsuoki Miyasu, Hyogo (JP); Takehiko Iguchi, Hyogo (JP); Koji Fujita, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO BENKI KABUSHIKI KAISHA, Tokyo (JP)

(21) Appl. No.: 11/642,781

(22) Filed: Dec. 21, 2006

(30) Foreign Application Priority Data
Dec. 28, 2005 (JP) 2005-379115

(51) Int. Cl. F21V 15/00

(52) U.S. Cl. 362/362

(57) ABSTRACT

A lamp housing having an opened side, wherein a light source lamp is disposed therein. The lamp housing comprises a cover that is removably attached to cover the opened side, and that has a cut-out portion, a wall that faces the opened side, and that has a hole, and a partition member provided so as to extend from the cut-out portion toward the hole of the wall so that a work space and an internal space of the housing is approximately partitioned by the partition member.

### CROSS-REFERENCES TO RELATED APPLICATION

This application claims priority from Japanese Patent Application No. 2005-379115 filed on Dec. 28, 2005, the contents of which are incorporated herein by reference in its entirety.

### TECHNICAL FIELD

Described herein is a lamp housing structure off a light source apparatus which is installed in a projection apparatus, such as a projector, and a lamp replacement method for a light source apparatus.

### BACKGROUND

In recent years, a digital cinema is becoming in use because a high quality screen image can be supplied in film showing, and distribution of the screen image is simple and convenient. Since a high brightness lamp is required as a light source of a projector apparatus for such a digital cinema in order to project a clear and powerful image onto a large screen, a xenon lamp which emits light close to sunlight is used. Moreover, a rated power consumption of an input thereof is specifically 2 to 3 kW.

FIG. 6 is a schematic view showing an example of a light source apparatus installed in a projector apparatus. The xenon lamp 70 is used as a light source. The sealing portion 71 which is provided in the side of an optical projection window 61 is located in midair. The sealing portion 72 provided in the other side is held by a lamp holding member 62, so that the xenon lamp is supported horizontally.

The internal pressure of the xenon lamp 70 becomes very high at time of operation, and the xenon lamp 70 is surrounded in all the directions thereof by the wall surfaces of a lamp housing 60 when the lamp 70 is accommodated in the lamp housing 60. A pair of reflective mirrors 63 and 64 which face each other are arranged inside the lamp housing 60. The mirror 63 arranged in the back side of the lamp housing 60 reflects light towards the front side projection window. The mirror 64 located in the front side catches light which will not go into the front optical projection window 61 from the lamp 70, and reflects it towards the back side mirror 64.

Where such a projector apparatus is installed in a movie theater and a lamp needs to be replaced with new one, the light source apparatus in which the lamp 70 is built in the lamp housing 60 is transported, and the entire lamp source apparatus is replacing with a new light source apparatus. Therefore, since the lamp 70 is always accommodated in the lamp housing 60 located in a projection room, and the main body of the lamp 70 is not taken out to the outside, the replacement of the lamp can be carried out safely. Since as an electric power supply mechanism for the lamp 70, a connector structure comprising an electric supply projection 66 and a receiver 69 as shown in FIG. 6 is employed so that the light source apparatus can be electrically connected to the projection apparatus only by placing it in a predetermined position of the projector apparatus, an operator does not take time to install the light source apparatus to the projector apparatus.

In such a light source apparatus 10, when the lamp 70 is installed, as shown in FIG. 7, a cover 65 in which side faces and a ceiling portion of the lamp housing 60 are integrally formed is taken out. And the lamp 70 is inserted from an opening of the front side mirror 64, and fixed to the lamp holding member 62. The lamp holding member 62 also serves as an electric power supply means for the lamp 70. After the lamp 70 is fixed thereto, a back side electrode (cathode) is connected to the electric power supply projection 66 led to the outside of the lamp housing 60. The electric power supply terminal 67 led from a front side electrode (anode) is connected to a terminal member 68 for electric power supply.

In recent years, a digital processing capability has been developed in every field so that highly fine images have been developed. For this reason, a high power output lamp is also demanded in order to project a fine and vivid image. Moreover, a large size screen has been also considered. Therefore, in such a case, a high brightness and high-output lamp is indispensable. In view of such a background described above, the light source apparatus using a 7 kW xenon lamp with a far larger input than that of the conventional lamp operated at the rated power consumption (2-3 kW) has recently been developed.

However, since not only the lamp main body but also the lamp housing in which the lamp is accommodated also grow in size as an input of such a lamp becomes larger, installation thereof in projector apparatus becomes complicated.

Moreover, since the size of such a lamp housing becomes too large to replace the entire light source apparatus as in the conventional matter in order to replace the lamp with new one after installation of the light source apparatus, the replacement of the lamp in the conventional manner become practically impossible. Then, although replacement of only lamps has been studied, there are many difficulties on installation work.

Specifically, detailed description thereof will be given below.

First of all, the lamp used as a light source is a short arc type xenon lamp in which electric discharge gas is enclosed in an arc tube under a pressure higher than atmospheric pressure even in a normal (room) temperature. Replacement of a lamp is not desirable if the light source apparatus is taken out from the projector apparatus in a projection room, and the box shaped cover of the lamp housing is taken out so as to carry out the replacement of lamps, because in such a case, the replacement of the lamps is time consuming. And in the conventional electric power supply means for the lamp, since the connector structure is employed in which electric connection is carried out by an insertion and engagement of the electric power supply projection and a receiver thereof in order to simplify the connecting operation, the connection thereof is easy. However, since a current value exceeds 100A if the input electric power of a lamp is 7 kW or more, interposition of a connector is not desirable from a viewpoint of safety and reliability. For this reason, it is advantageous to directly connect an electric power supply section of the lamp to an electric power line in a power unit.

However, as mentioned above, since highly pressurized electric discharge gas is enclosed in the lamp, an operator must be careful in a replacement operation so as not to contact with it accidentally whereby it takes time very much. Therefore, it is not desirable to perform wiring work every time the lamps are replaced from a viewpoint of safety and reliability. Thus, the light source apparatus will grow in size if the input of the lamp is increased so that maintenance workability will be worsened.

### SUMMARY

In view of the above-mentioned background, a lamp housing, and a protective cover for a lamp as set forth below is offered.

1. When a light source apparatus is installed in a projector apparatus, even if the lamp has been installed beforehand, electric power supply connection can be carried out safely. The light source apparatus may include the lamp housing, and a xenon lamp, a lamp holding member, reflective mirror(s), a relay terminal, an insulated member, and/or a protective cover.

2. Replacement of lamps can be carried out quickly, in a state where the light source apparatus is installed in a projector apparatus.

3. A lamp is not exposed to the outside during transportation of a light source apparatus.

Furthermore, it is an object of the present invention to provide a replacement method of a lamp of a light source apparatus in which workability is good and high safety and reliability thereof can be acquired.

The present lamp housing having an opened side, wherein a light source lamp is disposed therein, comprises a cover that is removably attached to cover the opened side, and that has a cut-out portion, a wall that faces the opened side, and that has a hole, and a partition member provided so as to extend from the cut-out portion toward the hole of the wall so that a work space and an internal space of the housing is approximately partitioned by the partition member.

The lamp housing may further comprise a reflective mirror that reflects light from the light source lamp, wherein a front side wall provided in a front side of the lamp house is removably provided.

Further, the present light source apparatus comprises a lamp housing having an opened side, and a wall that faces the opened side and that has a hole, a light source lamp disposed the lamp housing, a reflective mirror that guide light from the light source lamp to an front side projection window provided in the lamp housing, a cover that is removably attached to cover the opened side, and that has a cut-out portion, and a partition member provided so as to extend from the cut-out portion toward the hole of the wall so that a work space and an internal space of the housing is approximately partitioned by the partition member.

Moreover, the present protective cover for a lamp housing of a projector apparatus, in which the lamp housing has an opened side, and a lamp is disposed the in the lamp housing comprises a cover portion to be removably attached to the lamp housing to cover the opened side, and that has a cut-out portion, and a partition member provided so as to extend from the cut-out portion so that a work space and an internal space of the housing is approximately partitioned by the partition member when the protective cover is attached to the lam housing.

(1) Since one side wall of the lamp housing is removed so that the maintenance side is opened, replacement of the lamps can be carried out in a state where the light source apparatus is installed in the projector apparatus.

(2) In case that the light source apparatus is transported, since the maintenance side is covered with the protective cover which is removable, it is possible to transport the light source apparatus safely.

(3) In case that the light source apparatus is installed in the projector apparatus, wiring work can be carried out in a state where the protective cover is attached thereto. Therefore, the operation of installation can be safely carried out in a state where it is isolated from the lamp. Moreover, the protective cover is attached thereto and the wiring work can be carried out at time of replacement of the lamps, so that an operator can work on it safely.

(4) Without removing the light source apparatus from the projector apparatus, it is possible to remove or insert the lamp from the front side opening of the mirror after sliding the one end face located in a side of the optical projection window, so that the attachment or detachment operation of the lamp can be carried out easily.

### BRIEF DESCRIPTION OF DRAWINGS

Other features and advantages of the present lamp housing will be apparent from the ensuing description, taken in conjunction with the accompanying drawings, in which:

FIG. 1 is a perspective view of a light source apparatus, wherein a protective cover for transportation is attached;

FIG. 2 is a front side view of a light source apparatus, wherein a protective cover for transportation is attached thereto;

FIG. 3 is a perspective view explaining a lamp replacement process of a light source apparatus;

FIG. 4 is the diagram showing a process of removing a front section of a light source apparatus;

FIG. 5 is a diagram explaining a lamp replacement process of a light source apparatus;

FIG. 6 is a cross-sectional view of a light source apparatus in a conventional projector apparatus taken along a plane passing through an optical axis of a mirror; and

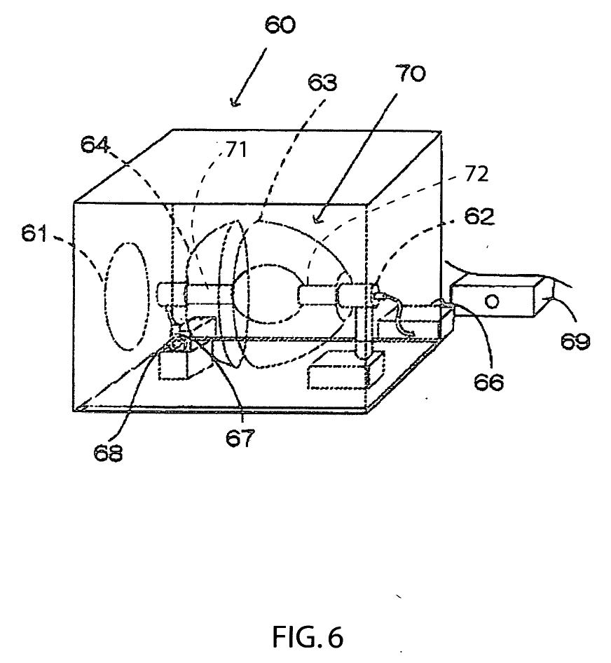

FIG. 7 is a schematic diagram showing an example of a conventional light source apparatus.

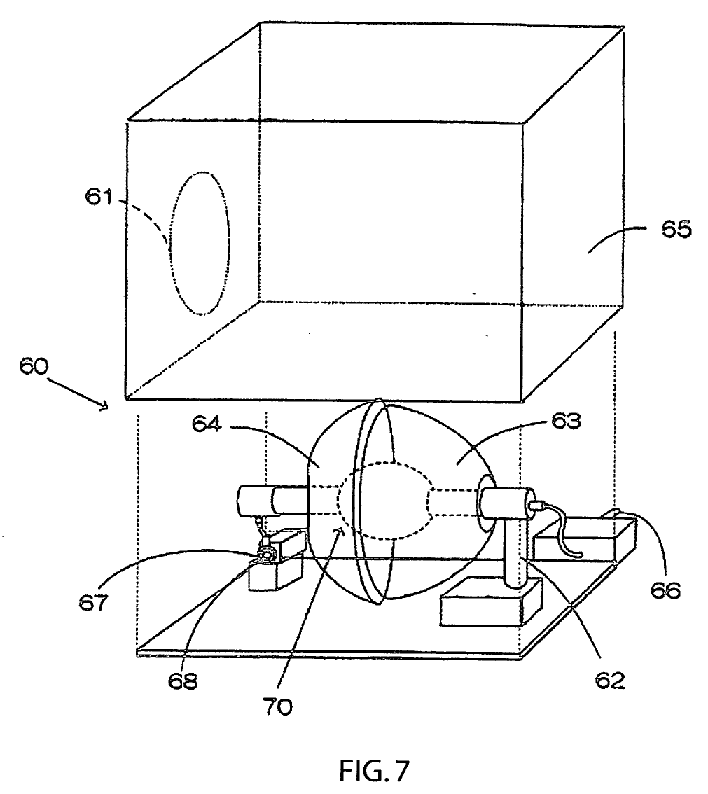

### DETAILED DESCRIPTION

While the claims are not limited to the illustrated embodiments, an appreciation of various aspects of the present lamp housing is best gained through a discussion of various examples thereof.

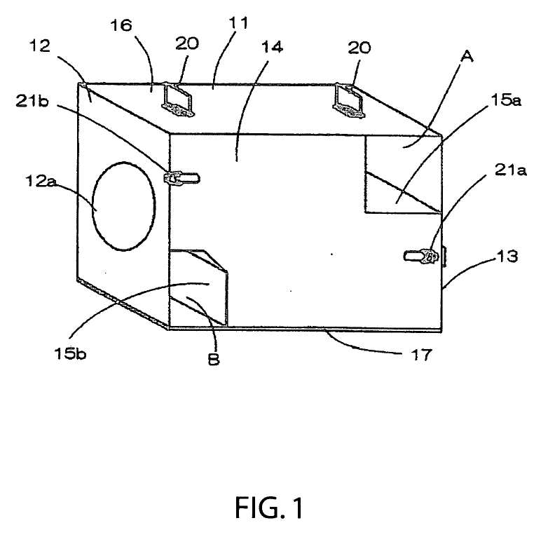

FIG. 1 is a perspective view of the present lamp housing, wherein a lamp housing has not been installed in a projector apparatus.

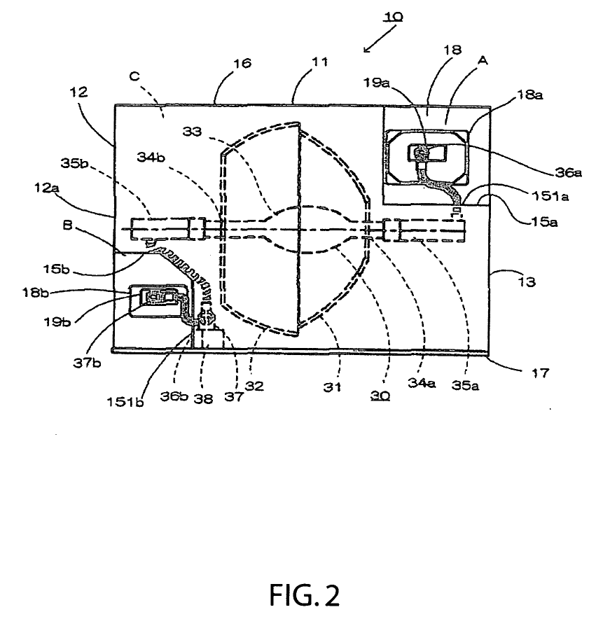

FIG. 2 is a front view of a lamp housing viewed from a maintenance side wherein a xenon lamp is installed therein. This view shows a state where certain wiring processing is performed after the lamp housing is installed in the projector apparatus. In addition, the broken lines show elements provided inside the lamp housing by the broken lines. The lamp holding member and the reflective mirror fixing member are omitted in the figure.

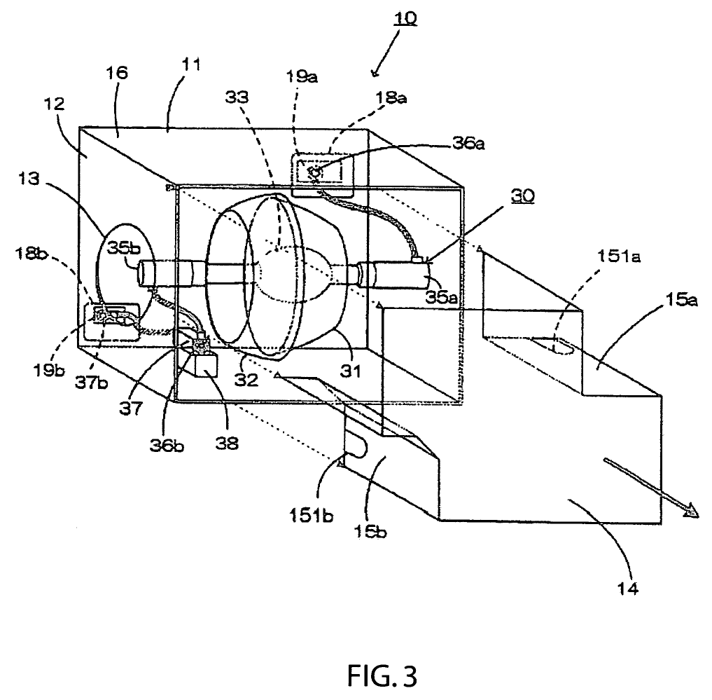

FIG. 3 is a perspective and exploded view explaining a process of lamp replacement.

Description of the structure of the lamp housing and a method for installing a lamp housing to the projector apparatus will be given below in detail.

In FIGS. 1 and 2, the appearance of the lamp housing 11 made from board material such as aluminum is a rectangle box shape. The lamp housing 11 comprises a front face section 12 in which an optical projection window 12a located in the left-hand side on the drawing sheet is formed, a rear face section 13 facing the front face section 12, a protective cover 14 located in the front side in the drawing sheet, which covers a maintenance section (opening), a back face section 18 facing the maintenance section (see FIG.2), an upper face section 16, and a bottom face section 17. Cut-out portions are formed in the protective cover 14 at an upper right portion and a lower left portion, respectively, and the first and second partition members 15a and 15b which extend from the respective edge portions thereof to the back side of the lamp housing are provided, respectively. A work space A is defined by the rear face section 13, the first partition member 15a, the ceiling plate 16 of the lamp housing 11, and a work space B is defined by the front face section 12, the partition member 15b, and the bottom face section 17. The partition members 15a and 15b are formed by bending board material which is the same as that of the protective cover 14, and is integrally formed with the protective cover 14 by welding. The work spaces A and B are used to perform electric supply connections of the cathode and the anode, respectively.

Handles 20 used for transportation are provided in the upper surface of the upper face section 16 of the lamp housing 11, and specifically, they are used to carry the lamp housing 10 in a projection room. For example, two stoppers 21a and 21b having a spring mechanism, respectively are attached to the protective cover 14. After the lamp housing 11 is installed in the projector apparatus, it is possible to easily take out the protective cover 14 from the housing main body (namely, the front face section 12, the rear face section 13, the upper face section 16, a bottom face section 17, and the back face section 18) when the stoppers 21a and 21b are released.

In FIG. 2, the broken line portions show a xenon lamp 30 and reflective mirrors 31 and 32. They are installed in an approximately airtightly sealed state in a lamp accommodation space C formed by the protective cover 14 and the walls of the housing main body at the time of installation of the protective cover 14. The xenon lamp 30 has a cathode and an anode (not illustrated) in the arc tube 33, and these electrodes are connected to the electric power supply terminals 36a and 36b through sealing portions 34a and 34b and metal mouthpieces 35a and 35b provided at the respective tips of the sealing portions, respectively. The electric power supply terminals 36a and 36b are led from the lamp accommodation space C to the work spaces A and B, respectively through the cut-out portions (151a, 151b) formed in the partition members 15a and 15b, respectively.

Through-holes 18a and 18b are formed in the back face section 18 of the lamp housing 11, and the work spaces A and B are connected to the outside space through the through-holes 18a and 18b. When the light source apparatus 10 is installed in a certain projector apparatus (not shown), external electric power supply terminals 19a and 19b of the projector apparatus can be seen through these through-holes 18a and 18b.

When the lamp housing 11 is first installed in the projector apparatus, the electric power supply terminal 36a led to the work space A is electrically connected to the external electric power supply terminal 19a. The other electric supply terminal 36b led to the work space B is connected to a relay terminal member 37 arranged through an insulated member 38 in the lamp housing 11 beforehand, and a terminal 37a which is electrically connected to the relay terminal member 37 is coupled with the external power supply terminal 19b. Therefore, the wiring process is completed by the two couplings.

The reason why only the other electric supply terminal 36b is connected to the external electric power supply terminal 19b through the relay terminal member 37 is that even when the lamp is broken, scattering thereof is prevented so that the front sealing portion 34b which is not fixed to the lamp holding member etc. may not damage the external device. Thus, in a state where a protective cover 14 is attached to the lamp housing 11, the electric power supply terminals 36a and 36b of the xenon lamp 30 are electrically connected to the external electric power supply terminals 19a and 19b on the projector apparatus side by using the first and second work spaces A and B.

After the electric power supply terminals 36a and 36b on the lamp side and the external electric power supply terminals 19a and 19b are connected, respectively, the protective cover 14 becomes unnecessary. Therefore,, the stoppers 21a and 21b of the protective cover 14 shown in FIG. 1 are released, and the protective cover 14 is pulled out in the direction shown by an arrow in FIG. 3. In this way, when the maintenance section of the lamp housing 11 is opened, the installation of the light source apparatus 10 to the projector apparatus is completed. In addition, since the maintenance section is covered by a casing (not shown) of the projector apparatus etc., the apparatus may not be operated in a state where the main body of the xenon lamp 30 is exposed to the outside.

Thus, the protective cover 14 is used at time of transportation and installation of the light source apparatus 10, and functions so that an operator may handle the light source apparatus safely. Since the xenon lamp 30 is surrounded by the lamp housing 11 in all the directions and the lamp accommodation space C is separated from the work spaces A and B by partitions, an operator may not touch the lamp 30 by mistake. On the other hand, it is possible to connect the electric power terminal 36a and the other electric power terminal 36b to the external electric power terminals 19a and 19b through the relay terminal member 37, certainly and quickly, so that the light source apparatus 10 can be installed efficiently and safely.

When the life span of the xenon lamp approaches to the end, the lamp 30 is replaced with new one in a state where the. light source apparatus remains in the projector apparatus.

Description of replacement of the lamp 30 will be given below, with reference to FIGS. 1-5.

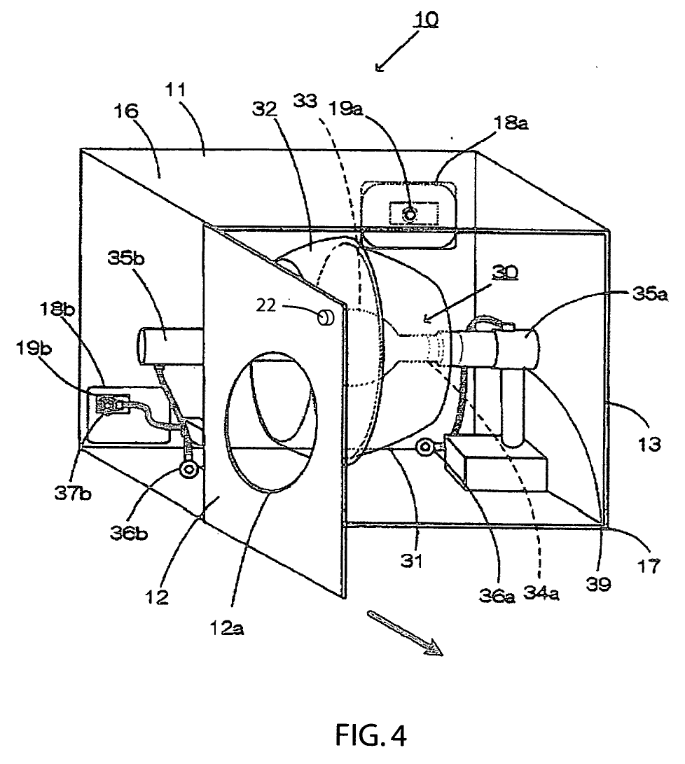

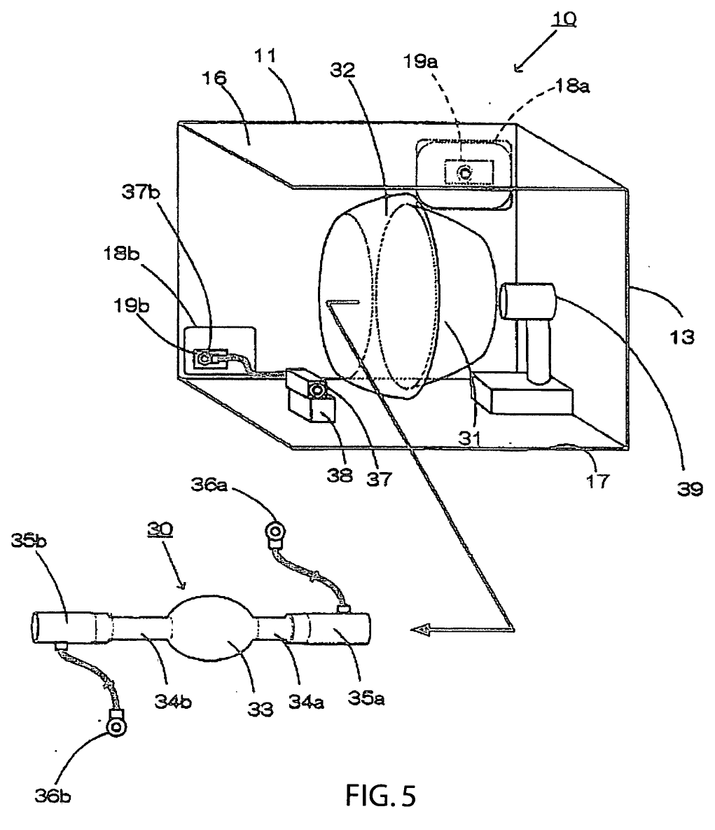

FIGS. 4 and 5 are perspective views of the light source apparatus to explain a lamp replacement process. The same numerals are assigned to the same elements throughout the figures.

(1) The casing of projector apparatus is removed so as to release the maintenance side of the lamp housing 11. FIG.3 shows the state where the protective cover 14 is removed, in which only the main body of the housing 11 is shown.

(2) The protective cover 14 is attached and fixed to the main body of the housing 11 by sliding it in the direction opposite to the direction of the arrow shown in FIG. 3. The lamp housing 11 is formed so that the maintenance side of the light source apparatus 10 is covered by the lamp housing, and the work spaces A and B are formed.

(3) The electric power supply terminal 36a, and the other electric power supply terminal 37b connected to the external electric power supply terminal 19aand the relay power supply member 37, respectively are detached therefrom. The protective cover 14 is again removed after they are released.

(4) As shown in FIG. 4, a fixing screw 22 which is provided in an upper part of the front section 12 in the main body of the lamp housing 14 is released. Since the front section 12 is slidable toward the front side, the front face section is detached so that the front side of the lamp housing 11, that is, the light emitting side thereof is opened.

(5) The used xenon lamp 30 is detached from the lamp holding member 39 and is taken out therefrom. FIG. 5 shows this state. Thus, since the light emitting side and front side portion of the light source apparatus are opened, maintenance can be easily carried out.

(6) A new xenon lamp is inserted from the front side opening of the reflective mirror 32, and is fixed to the lamp holding member 39.

(7) The front section 12 is attached by doing the reverse of the step (4).

(8) The lamp protective cover (14) is attached to the main body of the lamp housing 11, and the electric power supply terminal 36a is connected to the external electric power terminal 19a, and the other electric power terminal 36b is connected to the relay electric power supply terminal 37.

(9) The protective cover 14 is removed from the main body of the lamp housing 11, and the lamp replacement process is completed.

Thus, since a maintenance operation such as replacement of lamps is carried out while the front side portion of the lamp housing 11 and the maintenance side are opened, it is easy to work on it. When the external electric power supply terminal and lamp side electric power supply terminal are connected to each other, since the lamp accommodation space C and the work spaces A and B are partitioned, even though the connecting operation of the terminals is complicated, it is possible to carry out the connection operation safely with high reliability.

As explained above, since the maintenance side (front portion) of the light source apparatus is opened, it is possible to replace lamps while the light source apparatus is installed in the projector apparatus so that it is not necessary to transport the large light source apparatus every time lamps are replaced.

Moreover, before the light source apparatus is installed in the projector apparatus, the protective cover 14 which is removable is provided in the front side of the lamp housing 11 in order to cover the lamp 20, it is possible to transport the light source apparatus 10 without exposing the lamp 30 to the outside.

In addition, since the partition members 15a and 15b are provided on the protective cover 14 used for transportation, so that the space where the xenon lamp is installed, is partitioned from the work spaces A and B, is formed, an operator can work on the electric power connection operation of the lamp 30 on a safe condition so that it is possible to carry out the operation certainly and quickly even where the connection mechanism is complicated, for example, it is screw fastening mechanism.

Consequently, even in case of a large input electric power lamp which may not adopt a connector connection mechanism, it is possible to safely and easily carry out an operation without deteriorating maintenance workability of the conventional operation, so that a large optical output light source apparatus can be offered in compared with the size of the conventional light source apparatus.

As mentioned above, although the present invention is explained, referring to the figures, various change is possible for the present invention. For example, the lamp 30 for the light sources may be an extra-high pressure mercury lamp, a metal halide lamp, etc. instead of a xenon lamp.

The preceding description has been presented only to illustrate and describe exemplary embodiments of the lamp housing according to the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A lamp housing having an opened side, wherein a light source lamp is disposed therein, comprising:
a cover that is removably attached to cover the opened side, and that has a cut-out portion,
a wall that faces the opened side, and that has a hole, and
a partition member provided so as to extend from the cut-out portion toward the hole of the wall so that a work space and an internal space of the housing is approximately partitioned by the partition member.

2. The lamp housing, according to claim 1, further comprising a reflective mirror that reflect light from the light source lamp, wherein a front side wall provided in a front side of the lamp house is removably provided.

3. A light source apparatus comprising:
a lamp housing having an opened side, and a wall that faces the opened side and that has a hole;
a light source lamp disposed the lamp housing;
a reflective mirror that guide light from the light source lamp to an front side projection window provided in the lamp housing;
a cover that is removably attached to cover the opened side, and that has a cut-out portion, and
a partition member provided so as to extend from the cut-out portion toward the hole of the wall so that a work space and an internal space of the housing is approximately partitioned by the partition member.

4. A protective cover for a lamp housing of a projector apparatus, in which the lamp housing has an opened side, and a lamp is disposed the in the lamp housing comprising:
a cover portion to be removably attached to the lamp housing to cover the opened side, and that has a cut-out portion, and
a partition member provided so as to extend from the cut-out portion so that a work space and an internal space of the housing is approximately partitioned by the partition member when the protective cover is attached to the lamp housing.
